(19) United States
(12) Patent Application Publication
(10) Pub. No.: US 2007/0087825 A1
(43) Pub. Date: Apr. 19, 2007

(54) Pari-mutuel wagering system

(76) Inventors: Kim Hart, Surrey (GB); Laurel Marie Hart, Surrey (GB)

Correspondence Address: THELEN REID BROWN RAYSMAN & STEINER LLP, P. O. BOX 640640, SAN JOSE, CA, 95164-0640, US

(21) Appl. No.: 10/545,468

(22) PCT Filed: Feb. 12, 2003
(86) PCT No.: PCT/CA03/00206

§ 371 Date: Apr. 19, 2006

(51) Int. Cl. G06F 19/00

(52) U.S. Cl. 463/28; 463/6

(57) ABSTRACT

A pari-mutuel system, and more particularly, a pari-mutuel system relating to a real time virtual horse racing game wherein the outcome of such race is determined by a random number generator such that each competitor of the race has a statistically equal chance of winning. Players make wagers on a specific wager type wherein each wager type is associated with a pool. A predetermined portion of all wagers made is retained by the house and another predetermined portion of wagers made for specific wager types is redistributed into a pool wherein the odds of winning such pool are lowest in comparison to the other pools.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the public Patent Office file or records but otherwise reserves all copyright rights whatsoever.

### TECHNICAL FIELD

This invention relates to a pari-mutuel system, and more particularly, a pari-mutuel system in relation to a real time virtual horse racing game, the outcome of which is determined by a random number generator.

### BACKGROUND

To increase the chances of successfully wagering on racing games, such as horse racing, car racing, and dog racing, and winning a payout therefrom, players must develop expertise in considering a multitude of factors related to selecting a competitor (for example, a dog, a horse and its jockey, or a driver) and assessing the odds of success for each competitor. In order to develop such expertise, players usually collect and analyze a multitude of information to make a judgment on who to bet on, what type of bet to place, and how much to wager. Such information may include the type and condition of the track, the class of the race, the form of the competitor, and the experience of the jockey and the trainer. Acquiring the skill to accurately analyze such information is time consuming and the effort required to develop such skill may not pay off at the race track. As a result, novice players rarely return to the race track to wager because they enjoy little success due to their lack of expertise.

In addition to developing expertise in understanding the handicapping process in races such as horse racing, players also need to understand the different types of bets available. In most conventional horse racing games, there are up to ten types of wagers, including:

(1) Win: the player selects one horse and such horse has to cross the finish line first for the player to win;

(2) Place: the player selects one horse and such horse has to cross the finish line either first or second for the player to win;

(3) Show: the player selects one horse and such horse has to cross the finish line either first, second, or third for the player to win;

(4) Quinella: the player selects two horses and such two horses have to cross the finish line first and second, in either order, for the player to win;

(5) Exacta: the player selects two horses and their respective order of finish (i.e. either first or second) and such two horses have to cross the finish line in the exact order selected for the player to win;

(6) Trifecta: the player selects three horses and their respective order of finish (i.e. either first, second, or third) and such three horses have to cross the finish line in the exact order selected for the player to win;

(7) Superfecta: the player selects four horses and their respective order of finish (i.e. either first, second, third, or fourth) and such four horses have to cross the finish line in the exact order selected for the player to win;

(8) Daily Double: the player selects the winners of two consecutive races;

(9) Twin Trifecta: the player selects the first three horses to cross the finish line in two designated races; and

(10) Tri Super: the player wins a Trifecta in a first race and attempts to win a Superfecta in the next race.

To add to the confusion of the different types of wagers in conventional horse racing games, there are “box” or “wheel” type wagers which are a method of ordering a type of wager. “Box” or “wheel” type wagers apply to Exactas, Trifectas, and Superfectas only. For example, if a player is confident that certain horses have a greater likelihood of crossing the finish line first, but are uncertain as to the order of finish of such horses, the player may “box” such horses. If the horses in the box are the first two (for Exactas), three (for Trifectas), or four (for Superfectas) horses to cross the line, the player wins.

On the other hand, pari-mutuel wagering allows a player holding a winning ticket to divide the total amount in a pool (comprising of all wagers made for a particular game) in proportion to the player's wager. Typically, a pre-determined percentage of the pool is taken and retained by the house. Current pari-mutuel race gaming also requires players to have at least some expertise in order to win consistently. Most pari-mutuel race gaming available in the art incorporates a handicapping process which increases the difficulty of play and intimidates novice players. On the other hand, slot machines, casino games such as blackjack and roulette, lotteries, and scratch tickets are very popular because of their ease of play and availability. Novice players and the general public tend to gravitate towards easier games which are based more on luck and chance than skill.

### SUMMARY OF THE INVENTION

It is an object of this invention to provide a pari-mutuel system in relation to a racing game wherein each competitor of a race has a statistically equal chance of winning such race, thereby eliminating the difficult handicapping process typically associated with conventional racing games.

It is a further object of this invention to provide a pari-mutuel system in relation to a racing game comprising of separate pools for different wager types wherein a predetermined portion of wagers made by all players is redistributed into a particular pool where the odds of winning such pool are lowest in comparison to the other pools.

The present invention discloses a pari-mutuel system comprising a virtual race, a first and second group of players, and a first and second pool. Each competitor in such virtual race is associated with an indicia. Each player in the first and second group selects a wager type, which comprises selecting at least one indicia and selecting a position of finish of the competitor associated with the selected indicia, and makes a wager on such wager type. The first pool is associated with a first wager type and comprises a portion of wagers made on the first wager type wherein each player in the first and second group contribute equal predetermined portion of such wagers to the first pool. The second pool is associated with a second wager type and comprises a portion of wagers made on the second wager type wherein each player in the first group contribute a greater predetermined portion of such wagers to the second pool than each player in the second group. The odds of winning the second pool are less than the first pool. An order of indicia is determined based on the order of finish of the competitors in the virtual race, which is determined by a random number generator such that each of the competitors has an equal chance of winning the race. A share of the first pool proportionate to the wagers made on the first wager type is distributed to each of the players in the first and second group if the selected position of finish by the players in the first or second group is the same as the order of indicia. Similarly, a share of the second pool proportionate to the wagers made on the second wager type is distributed to each of the players in the first and second group if the selected position of finish by the players in the first or second group is the same as the order of indicia.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is a screen shot of a preferred embodiment of a virtual race displayed via the Internet;

FIG. 2 is a block diagram of a preferred embodiment of a pari-mutuel system incorporating the invention;

FIG. 3 is a screen shot of a homepage of a website for players from different countries to access the off-track wagering means;

FIG. 4 is a screen shot of a page from a website guiding players to sign up for a personal account to make wagers;

FIG. 5 is a screen shot of a new account registration page from a website;

FIG. 6 is a screen shot of a wagering page from a website;

FIG. 7 is a flow chart of the wagering process of a player; and

FIG. 8 is a block diagram of a preferred embodiment of the different pool types.

### DETAILED DESCRIPTION OF PREFERRED EMBODIMENTS

Throughout this document, the term “competitors” means the horses and jockeys participating in a race and the term “players” means the people wagering on the results of the race.

Virtual Race

In a preferred embodiment, the present invention provides for a pari-mutuel system, more particularly, a pari-mutuel system in relation to a virtual horse racing game wherein each of the competitors have a statistically equal chance of winning the virtual race. Competitors of the virtual race are each associated with an indicia such that players can make wagers by selecting the indicia associated with one or more competitors and selecting such selected competitors' positions of finish in the virtual race. In a preferred embodiment, the indicia associated with the competitors are numbers, but any other identifying means such as letters, symbols, or colours may be used. Typically, the indicia of the competitors are displayed on the saddle cloth of each competitor.

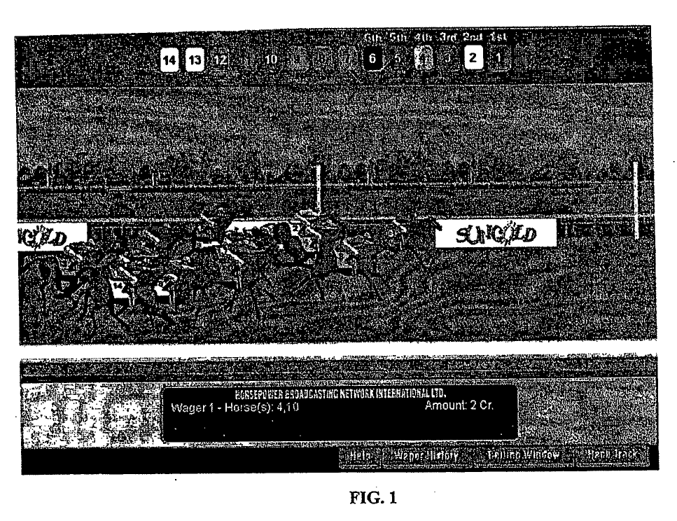

The number of competitors that can participate in the virtual race is unlimited, but typically, there are 14 competitors participating in the virtual race. The number of virtual races is unlimited and are typically run every 90 seconds. Preferably, the virtual race is run in real time and displayed on a video screen via network means known in the art, such as computer networks and the Internet, as seen in FIG. 1.

All the competitors have an equal chance of winning the virtual race. In a preferred embodiment, a computer based random number generator system is used to create random results. Other random number generating means similar to those of most lotteries may be used.

Making a Wager

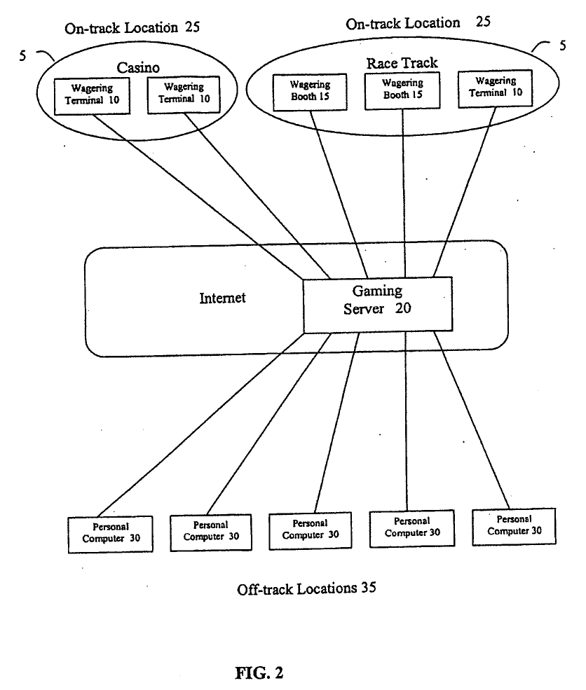

Players must make their wagers prior to the virtual race. Typically, the minimum wager for the virtual race is $2.00. As seen in FIG. 2, wagering means are provided on-track and off-track. On-track wagering means 5 include wagering terminals 10 available in the art or conventional wagering booths 15. Such on-track wagering means are typically connected to a gaming server 20. On-track wagering terminals 10 and booths 15 may be made available in any on-track locations 25 such as casinos, race tracks, or any other sites where such terminals and booths may be legally permissible.

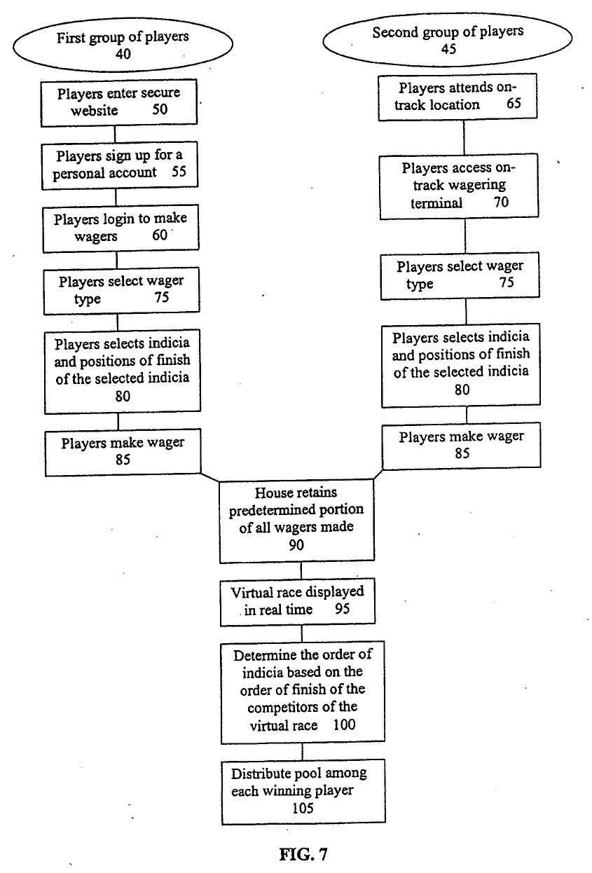

As seen in FIG. 7, to make a wager using on-track wagering means 5 such as wagering terminal 10, players must attend an on-track location (step 65) in order to access a wagering terminal (step 70).

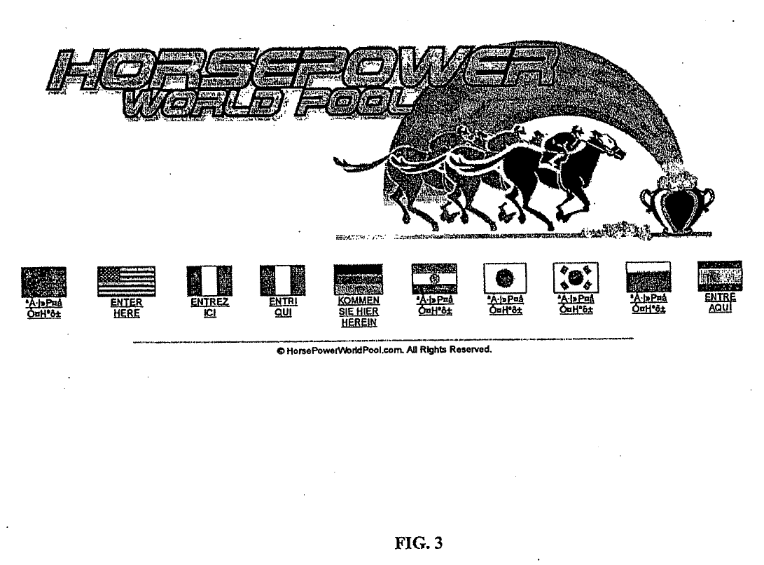

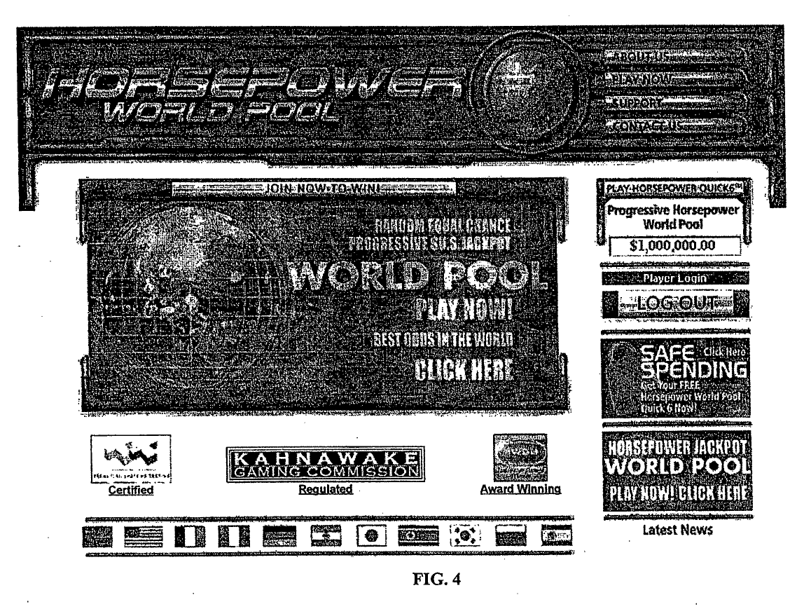

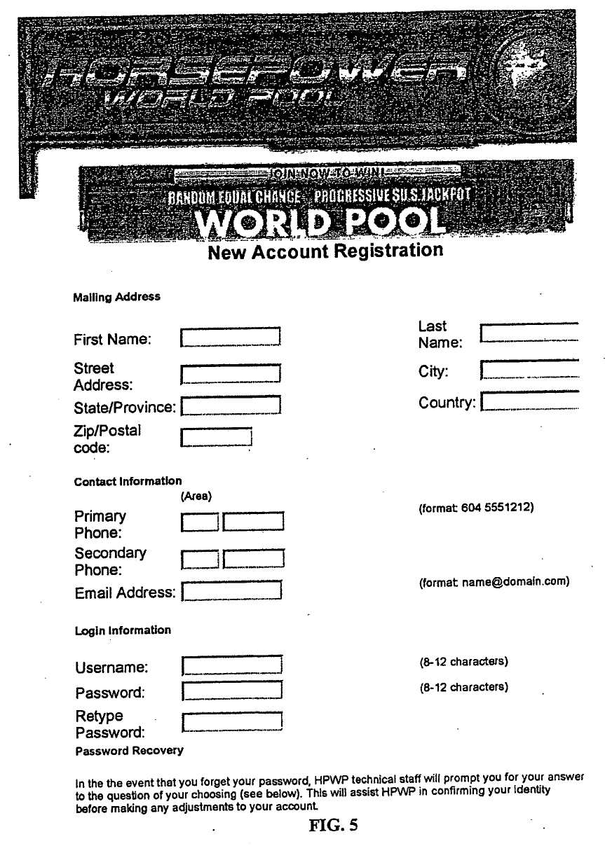

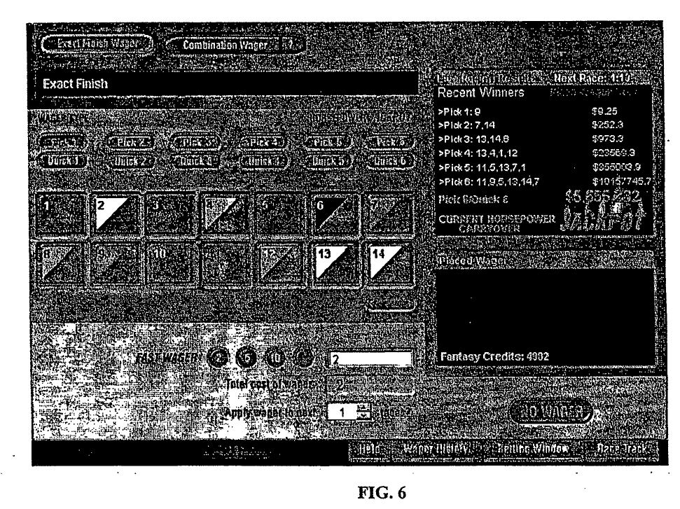

Off-track wagering means include Internet based wagering systems accessible through Internet connections. For example, off-track wagering means may be accessible from personal computers 30 which are available in many off-track locations 30 including internet cafes, homes, and offices, as seen in FIG. 2. Such Internet based wagering systems are also typically connected to gaming server 20. In a preferred embodiment, the house provides a secure official website where players may sign-up for a personal account and login to make wagers, as seen in FIGS. 3 to 5. A wagering page is provided for players to select a wager type (described below) and make a wager, as seen in FIG. 6. Typically, the last 20 winning numbers and dollars won per player are displayed on such wagering page.

To make a wager using off-track wagering means, players enter the website (step 50) and provide basic contact information to create a personal account (step 55) and provide a username and password to login, as seen in FIG. 7. After players login (step 60), software for a wagering system is installed on the players' computer to enable such players to make wagers (step 85).

In a preferred embodiment, players that make wagers using off-track wagering means form a first group of players 40 and players that make wagers using on-track wagering means form a second group of players 45, as seen in FIG. 7. In an alternative embodiment, first group of players 40 make wagers at a different location from second group of players 45. For example, first group of players 40 make wagers in Country A, Casino A, or Race Track A and second group of players 45 make wagers in Country B, Casino B, or Race Track B.

Wager Types

As seen in FIG. 7, players from both groups must select a wager type (step 75).

Players are required to select at least one indicia and the position of finish of such selected indicia (step 80). Players then make a wager (step 85) on their selections.

Different wager types are available to players in the first and second group. In a preferred embodiment, players can make wagers on the following wager types:

1) Pick 1: A player must select one indicia. The competitor associated with such selected indicia must finish first in the virtual race in order for the player to win a portion of the pool for the Pick 1 wager type (described below).

2) Pick 2: A player must select two indicia and the positions of finish for each of the two competitors associated with the selected indicia. If the order of indicia based on the order of finish of the competitors of the virtual race is the same as the selected positions of finish for each of the two competitors associated with the selected indicia, the player wins a portion of the pool for the Pick 2 wager type (described below).

3) Pick 3: A player must select three indicia and the positions of finish for each of the three competitors associated with the selected indicia. If the order of indicia based on the order of finish of the competitors of the virtual race is the same as the selected positions of finish for each of the three competitors associated with the selected indicia, the player wins a portion of the pool for the Pick 3 wager type (described below).

4) Pick 4: Each player must select four indicia and the positions of finish for each of the four competitors associated with the selected indicia. If the order of indicia based on the order of finish of the competitors of the virtual race is the same as the selected positions of finish for each of the four competitors associated with the selected indicia, the player wins a portion of the pool for the Pick 4 wager type (described below).

5) Pick 5: A player must select five indicia and the positions of finish for each of the five competitors associated with the selected indicia. If the order of indicia based on the order of finish of the competitors of the virtual race is the same as the selected positions of finish for each of the five competitors associated with the selected indicia, the player wins a portion of the pool for the Pick 5 wager type (described below).

6) Pick 6: A player must select six indicia and the positions of finish for each of the six competitors associated with the selected indicia. If the order of indicia based on the order of finish of the competitors of the virtual race is the same as the selected positions of finish for each of the six competitors associated with the selected indicia, each player wins a portion of the pool for the Pick 6 wager type (described below).

The wager types, and therefore the number of indicia the players may select need not be limited to those described above. Players may select indicia and positions of finish of such selected indicia up to the total number of competitors in the virtual race. For example, Pick 7 (selecting seven indicia and the positions of finish for each of the seven competitors associated with the selected indicia), Pick 8 (selecting eight indicia and the positions of finish for each of the eight competitors associated with the selected indicia), and Pick 9 (selecting nine indicia and the positions of finish for each of the nine competitors associated with the selected indicia) wager types may also be made available. In an alternative embodiment, players may select a wager type and the selection of the indicia and the positions of finish may be a randomly determined by an automated process.

In a preferred embodiment, players in the second group 45 can only make wagers on Pick 1 and Pick 6 wager types and players in the first group 40 can make wagers on all the wager types described above (Pick 1 to Pick 6). In an alternative embodiment, players in the first group 40 have an additional wagering option. Instead of selecting the exact positions of finish of each of the competitors associated with the selected indicia, each player in the first group 40 may make additional wagers on every possible combination of positions of finish of the competitors associated with the selected indicia. More particularly, if a player in the first group 40 selects two indicia (competitor 3 and competitor 8), such player may make additional wagers on every possible combination of positions of finish for each of the two competitors associated with the selected indicia (i.e. the player will make a wager on competitor 3 placing first and competitor 8 placing second and a second wager on competitor 8 placing first and competitor 3 placing second). In the preferred embodiment, players in the first group 40 may make such additional wagers on every possible combination of positions of finish if they select between 2 and 6 indicia. Because the wager types, and therefore the number of indicia the players in first group 40 may select need not be limited to a maximum of six indicia, such players may make additional wagers on every possible combination of positions of finish if they select indicia up to the total number of competitors in the virtual race.

The Pools

After the time to make a wager on a particular race has expired, the race is displayed in real time (step 95) to determine the order of indicia based on the order of finish of each competitor (step 100). If a player is successful in its selections such that the order of indicia based on the order of finish of the competitors in the virtual race is the same as the positions of finish selected by the player, such player will win, and a portion of a pool proportionate to the amount the player wagered will be distributed to such winning player (step 105). If none of the players win, the value of the pool carries forward to the next virtual race.

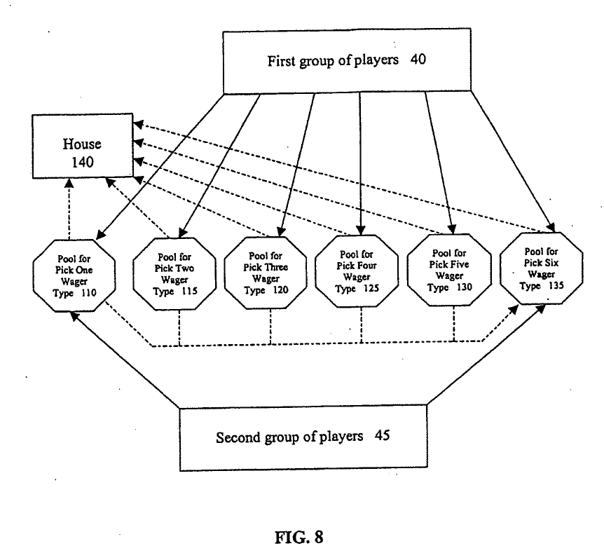

The pool comprises a predetermined portion of the wagers made by the players. In a preferred embodiment, each wager type is associated with its own pool, as seen in FIG. 8. More particularly, the pool for the Pick 1 wager type 110 is comprised of a predetermined portion of all wagers made for the Pick 1 wager type; the pool for the Pick 2 wager type 115 is comprised of a predetermined portion of all wagers made for the Pick 2 wager type; the pool for the Pick 3 wager type 120 is comprised of a predetermined portion of all wagers made for the Pick 3 wager type; the pool for the Pick 4 wager type 125 is comprised of a predetermined portion of all wagers made for the Pick 4 wager type; the pool for the Pick 5 wager type 130 is comprised of a predetermined portion of all wagers made for the Pick 5 wager type; and the pool for the Pick 6 wager type 135 is comprised of a predetermined portion of all wagers made for the Pick 6 wager type.

Typically, the house 140 retains a predetermined portion of all wagers made for any particular wager type (step 90), as seen in FIG. 7. In a preferred embodiment, the house 140 retains 20%-30% of all wagers made for each of Pick 1, Pick 2, Pick 3, Pick 4, Pick 5, and Pick 6, as seen in FIG. 8. Furthermore, to encourage players to make wagers on Pick 6 (because the odds of winning are lower than the other wager types), an additional predetermined portion of all wagers made for each of Pick 1, Pick 2, Pick 3, Pick 4, and Pick 5 wager types is redistributed into the pool for the Pick 6 wager type. Typically, 5%-10% of all such wagers on the other wager types are redistributed to the pool for the Pick 6 wager type, as seen in FIG. 8. Because only players in the first group 40 can make wagers on Pick 2, Pick 3, Pick 4, and Pick 5 wager types, such players contribute a greater portion of wagers to the pool for the Pick 6 wager type.

As an example, if 1400 players each make $2.00 wagers on the Pick 1 wager type and 100 players wager on each of the 14 competitors, the total of all wagers made for the Pick 1 wager type would be $2800. If the house retains 20% of all wagers made (i.e. $560.00) and 5% of all such wagers (i.e. $140.00) is redistributed into the pool for the Pick 6 wager type, there will be $2100.00 in the pool for the Pick 1 wager type to distribute to the winners. Because 100 players each wagered $2.00 on the competitor that finished first in the race, each of such players will receive $21.00 in winnings (i.e. $2100.00÷100 winners=$21.00 per winner).

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

1. A pari-mutuel system comprising:
(a) a virtual race wherein each competitor in said virtual race is associated with an indicia;
(b) a first and second group of players, each of said players in said first and second groups selecting a wager type comprising:
(i) selecting at least one of said indicia; and
(ii) selecting a position of finish of said competitor associated with said selected indicia; and
making a wager on said wager type;
(c) a first pool associated with a first wager type comprising a portion of said wagers made on said first wager type wherein each of said players in said first and second group contribute equal predetermined portions of said wagers to said first pool;
(d) a second pool associated with a second wager type comprising a portion of said wagers made on said second wager type wherein each of said players in said first group contribute a greater predetermined portion of said wagers to said second pool than each of said players in said second group and wherein the odds of winning said second pool are less than said first pool;
(e) wherein an order of indicia is determined based on an order of finish of said competitors of said virtual race wherein said order of finish is determined by a random number generator such that each of said competitors has an equal chance of winning said virtual race;
(f) wherein a share of said first pool proportionate to said wagers made on said first wager type is distributed to each of said players in said first and second group if said selected position of finish by said player in said first or second group is the same as said order of indicia; and
(g) wherein a share of said second pool proportionate to said wagers made on said second wager type is distributed to each of said players in said first and second group if said selected position of finish by said players in said first or second group is the same as said order of indicia.

2. The pari-mutuel system of claim 1 wherein said first pool carries over to a following race if none of said players in said first or second group wins said share of said first pool.

3. The pari-mutuel system of claim 2 wherein and second pool carries over to a following race if none of said players in said first or second group wins said share of said second pool.

4. The pari-mutuel system of claim 3 wherein said players in said first group use an off-track wagering means and said players in said second group use an on-track wagering means.

5. The pari-mutuel system of claim 4 wherein at least one of said players in said first or second group make said wager on said first wager type wherein said first wager type is a Pick 1 wager type.

6. The pari-mutuel system of claim 5 wherein at least one of said players in said first or second group make said wager on said second wager type wherein said second wager type is a Pick 6 wager type.

7. The pari-mutuel system of claim 6 wherein each of said players in said first group may make an additional wager on every possible combinations of said positions of finish for each indicia selected for said Pick 6 wager type.

8. The pari-mutuel system of claim 6 wherein at least one of said players in said first group:
(a) make said wager on a Pick 2 wager type;
(b) wherein a pool associated with said Pick 2 wager type comprises a portion of said wagers made on said Pick 2 wager type wherein each of said players in said first group contribute a predetermined portion of said wagers to said second pool; and
(c) win a share of said pool associated with said Pick 2 wager type proportionate to said wager made on said Pick 2 wager type if said selected positions of finish for said Pick 2 wager type is the same as said order of indicia.

9. The pari-mutuel system of claim 8 wherein each of said players in said first group may make an additional wager on every possible combinations of said positions of finish for each indicia selected for said Pick 2 wager type.

10. The pari-mutuel system of claim 8 wherein said pool associated with said Pick 2 wager type carries over to a following race if none of said players in said first group wins said share of said pool associated with said Pick 2 wager type.

11. The pari-mutuel system of claim 10 wherein at least one of said players in said first group:
(a), make said wager on a Pick 3 wager type;
(b) wherein a pool associated with said Pick 3 wager type comprises a portion of said wagers made on said Pick 3 wager type wherein each of said players in said first group contribute a predetermined portion of said wagers to said second pool; and
(c) win a share of said pool associated with said Pick 3 wager type proportionate to said wager made on said Pick 3 wager type if said selected positions of finish for said Pick 3 wager type is the same as said order of indicia.

12. The pari-mutuel system of claim 11 wherein each of said players in said first group may make an additional wager on every possible combinations of said positions of finish for each indicia selected for said Pick 3 wager type.

13. The pari-mutuel system of claim 11 wherein said pool associated with said Pick 3 wager type carries over to a following race if none of said players in said first group wins said share of said pool associated with said Pick 3 wager type.

14. The pari-mutuel system of claim 13 wherein at least one of said players in said first group:
(a) make said wager on a Pick 4 wager type;
(b) wherein a pool associated with said Pick 4 wager type comprises a portion of said wagers made on said Pick 4 wager type wherein each of said players in said first group contribute a predetermined portion of said wagers to said second pool; and
(c) win a share of said pool associated with said Pick 4 wager type proportionate to said wager made on said Pick 4 wager type if said selected positions of finish for said Pick 4 wager type is the same as said order of indicia.

15. The pari-mutuel system of claim 14 wherein each of said players in said first group may make an additional wager on every possible combinations of said positions of finish for each indicia selected for said Pick 4 wager type.

16. The pari-mutuel system of claim 14 wherein said pool associated with said Pick 4 wager type carries over to a following race if none of said players in said first group wins said share of said pool associated with said Pick 4 wager type.

17. The pari-mutuel system of claim 16 wherein at least one of said players in said first group:
(a) make said wager on a Pick 5 wager type;
(b) wherein a pool associated with said Pick 5 wager type comprises a portion of said wagers made on said Pick 5 wager type wherein each of said players in said first group contribute a predetermined portion of said wagers to said second pool; and
(c) win a share of said pool associated with said Pick 5 wager type proportionate to said wager made on said Pick 5 wager type if said selected positions of finish for said Pick 5 wager type is the same as said order of indicia.

18. The pari-mutuel system of claim 17 wherein each of said players in said first group may make an additional wager on every possible combinations of said positions of finish for each indicia selected for said Pick 5 wager type.

19. The pari-mutuel system of claim 17 wherein said pool associated with said Pick 5 wager type carries over to a following race if none of said players in said first group wins said share of said pool associated with said Pick 5 wager type.

20. The pari-mutuel system of claim 1 wherein the number of competitors in said virtual race is fourteen.

21. The pari-mutuel system of claim 1 wherein said predetermined portion of wagers contributed to said second pool is between 5%-10% of said wagers.

22. The pari-mutuel system of claim 1 wherein said pari-mutuel system is operated by a house.

23. The pari-mutuel system of claim 22 wherein a predetermined portion of all said wagers made on all said wager types is retained by said house.

24. The pari-mutuel system of claim 23 wherein said predetermined portion retained by said house is between 20%-30% of all said wagers.

25. The pari-mutuel system of claim 1 wherein each of said players in said first and second group may select any of said wager types and selection of said indicia and said positions of finish of said indicia may be randomly determined by an automated process.
